(19) United States
(12) Patent Application Publication
(10) Pub. No.: US 2011/0020619 A1
(43) Pub. Date: Jan. 27, 2011

(54) Polypropylene-Based Elastomer Coating Compositions

(76) Inventors: LINDA M. VAN DEN BOSSCHE, Zwijndrecht (BE); Nancy Georgette Vogelaers, Leefdaal (BE)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 12/814,236

(22) Filed: Jun. 11, 2010

Related U.S. Application Data
(60) Provisional application No. 61/227,997, filed on Jul. 23, 2009.

(51) Int. Cl. B32B 27/08; C08F 210/06; D04H 13/00; D03D 25/00; B32B 27/10; B32B 15/085; B32B 3/10; B32B 27/32; B05D 1/00; B05D 1/36; B32B 37/12

(52) U.S. Cl. 428/201; 526/348; 442/59; 428/513; 428/461; 428/516; 428/523; 428/219; 427/209; 427/407.1; 156/326

(57) ABSTRACT

Composite materials comprising propylene-based copolymer coating or tie layers disposed on one or more substrates are set forth herein. In one or more embodiments, the coating compositions comprise propylene and from about 3 to about 25 wt % units derived from ethylene and/or a C₄-C₈ alpha-olefin, and have a melting temperature less than about 105° C. and a heat of fusion less than about 75 J/g. Processes for forming such composite materials, such as by monoextrusion or coextrusion, are also provided.

### CROSS REFERENCE TO RELATED APPLICATIONS

This application claims the benefit of and priority to Provisional Application No. 61/227,997, filed Jul. 23, 2009, the disclosures of which are incorporated by reference in their entireties.

### Field of the Invention

The present invention is directed to composite materials comprising propylene-based copolymer coating layers disposed on one or more substrates. In one or more embodiments, the coating compositions comprise propylene and from about 3 to about 25 wt % units derived from ethylene and/or a C₄-C₈ alpha-olefin, and have a melting temperature less than about 105° C. and a heat of fusion less than about 75 J/g. Processes for forming such composite materials are also provided.

### BACKGROUND OF THE INVENTION

Composite structures are well known in the polymer field, and may include laminated or coated substrates. In extrusion lamination, structures can be produced by laminating substrates using an extruded, molten layer, which acts to “tie” or adhere the layers together. It may be referred to as a “tie layer”. In extrusion coating, a coating layer is applied to a substrate, often by extruding the coating layer onto the substrate.

The laminated layers for a laminated substrate or the base and coating layers for an extrusion coated substrate may not be compatible from an adhesion point of view, depending on the nature of the materials forming the layers. That is to say, there can be cases where a satisfactory bond does not exist between a substrate and a coating layer, or where no single tie layer material is available that provides a satisfactory bond between substrate and coating layers. To remedy poor bonding between the constituent layers and permit the combination of more disparate layers, a primer or an adhesive may be applied in a diluent of an organic solvent or emulsified in an aqueous diluent to one of the layers to be laminated or extrusion coated before a coating or tie layer is applied.

The term “primer” in this specification is used to mean a polymeric material which contains oxygen and/or nitrogen atom containing moieties and is applied at low dry application weights of less than 1 g/m2 in a removable diluent. The primer increases the potential for reactive bonding of a coating or tie layer and provides a clean, contaminant free surface to assist the wetting out of a molten extruded coating or tie layer and to improve bonding at a chill roll. Chemical primers may be applied at low dry application weights, as low as 0.004 g/m2. Primers can be solvent based and include polyurethanes, polyethylene-imine, polyesters, organo-functional amines and polyamides.

Sufficient time must be allowed on a continuous line to allow the primer to be absorbed and the diluent to be removed by drying and this limits the line speeds and increases the costs. Furthermore the layer to be primed must be sufficiently porous to absorb the primer. Subsequent to the application of the primer, a coating layer or tie layer can be applied in a separate step and the ultimate structure can be formed by lamination or coating.

A majority of primers available commercially are water-based so that the final structure may be sensitive to water and water vapor, limiting the usefulness of the structures as far as outdoor applications are concerned. Furthermore the primer may have a yellowing effect on the coated materials, which may be important in applications where transparency is desired. As with adhesive lamination, the use of a primer may limit the operational line speed on a continuous lamination line, especially with water based primers because the water or other medium used for applying the adhesive must be removed before the lamination can proceed further.

It is among the objects of the invention to provide a process that permits fast extrusion lamination and reduces any restrictions in terms of substrate selection, processing speed arising from the need for primer solvent, or diluent removal.

### BRIEF DESCRIPTION OF THE FIGURES

FIG. 1 depicts water vapor transmission rate (in g/m²/24 hrs @ 90% RH and 37.8° C.) as a function of polymer density for 25 micron films formed from copolymers of the present invention as well as for a number of comparative polymers.

FIG. 2 depicts seal strength (in N/30mm) as a function of sealing temperature (° C.) for 25 g/m² (“gsm”) coatings on woven fabric, including coatings formed from copolymer blends of the present invention and reference materials.

FIG. 3 depicts seal strength (in N/15 mm) as a function of sealing temperature (° C.) for 25 gsm coatings on oriented polypropylene (“OPP”), including coatings formed from copolymer blends of the present invention and coatings of LDPE on kraft paper.

FIG. 4 depicts hot tack (in N/30 mm) as a function of sealing temperature (° C.) for 25 gsm coatings on primerless OPP for coatings formed from EVA and from EVA blended with copolymers of the present invention.

FIG. 5 depicts seal strength for 25 gsm coatings on OPP onto printed boards for blends of EVA and copolymers of the present invention. FIG. 5 shows adhesion (in N/15 mm) when the coatings are thermal laminated onto three colors of ink at 100° C. and 120° C.

FIG. 6 depicts adhesion (in N/15 mm) at high and low extrusion temperatures for 30 gsm tie layers comprising copolymers of the present invention used to adhere woven polypropylene fabric to reverse printed OPP films.

FIG. 7 depicts shear viscosity (in Pa-s) as a function of shear rate (in sec ⁻¹) for a copolymer of the present invention and for several comparative polymers at 190° C.

FIG. 8 depicts shear viscosity (in Pa-s) as a function of shear rate (in sec ⁻¹) for a copolymer of the present invention and for several comparative polymers at 290° C.

FIG. 9 depicts adhesion (in N/15 mm) to primerless OPP films for monoextruded 15 gsm and 25 gsm coatings comprising copolymers of the present invention, as well as for monoextruded coatings comprising comparative polymers.

FIG. 10 depicts bond strength (in N/15 mm) for 25 gsm coatings on woven polypropylene fabrics for copolymer blends of the present invention and for a comparative polymer.

FIG. 11 depicts bond strength (in N/15 mm) for 40 gsm coatings on woven polypropylene fabrics for copolymer blends of the present invention coextruded with sealing layers formed from polyethylene and from a copolymer of the present invention.

### DETAILED DESCRIPTION OF THE INVENTION

The present invention is directed to composite materials and processes for forming the same. In one or more embodiments, the composite material comprises a substrate and a coating disposed on at least one side of the substrate, wherein the coating comprises a propylene-based copolymer. In one or more embodiments, the propylene-based copolymer comprises propylene and from about 3 to about 25 wt % units derived from ethylene, and has a melting temperature less than about 105° C. and a heat of fusion less than about 75 J/g. In further embodiments, a process for forming a composite material is provided, which comprises providing a substrate and extruding onto at least one side of the substrate a propylene-based copolymer comprising from about 3 to about 25 wt % units derived from ethylene and having a melting temperature less than about 105° C. and a heat of fusion less than about 75 J/g.

As used herein, the term “copolymer” is meant to include polymers having two or more monomers, optionally with other monomers, and may refer to interpolymers, terpolymers, etc. The term “polymer” as used herein includes homopolymers and copolymers.

### Substrates

The composite materials of the present invention comprise one or more substrate layers. The one or more substrates may be of any form and may be formed from any material known by those in the art for the formation of commercial articles. Such commercial articles include, but are not limited to, bags, pouches, wraps, liners, signboards, roofing and construction materials, clothing, undergarments, medical gowns and sheets. For example, the substrates may comprise films, membranes, tapes, woven fabrics, nonwoven fabrics, raffia, sheets, or boards. The substrates may or may not be extensible. In these or other embodiments, the substrates may be formed from plastic, paper, cardboard, wood, metal, foil, or combinations thereof. In one or more embodiments, the substrate is selected from polypropylene film, oriented polypropylene film, polypropylene-based woven or nonwoven fabrics, paper, board, and aluminum foil.

In one or more embodiments, the substrates may be printed or reverse printed. By “reverse printed” is meant a process in which lettering, symbols, drawings, photographs, or other artwork is printed in a mirror image on the opposite side of a substrate (the “back” side) from the side intended to be viewed by consumers or the end user (the “front” side). In this manner, when the substrate is viewed from the front side, the printed image shows through from the back side and is viewable in its intended orientation (i.e., no longer as a mirror image).

In some embodiments, the substrates may comprise a homopolymer or copolymer of propylene. The substrates may be unoriented, or may be uniaxially oriented in the machine or transverse direction, or may be biaxially oriented (i.e., in both the machine and transverse directions). As used herein, the phrase “oriented polypropylene” or “OPP” includes both homo- and copolymers of propylene and includes both uniaxially and biaxially oriented polypropylene substrates.

In further embodiments, the substrates may comprise a homopolymer or copolymer of ethylene. In one or more embodiments, one or more substrates may comprise a copolymer of ethylene with a C₄-C₈ alpha-olefin comonomer. In one or more embodiments, the ethylene copolymer is an ethylene-octene copolymer having a density of from about 0.875 to about 0.910 g/cm³. Suitable ethylene-octene copolymers are available under the trade name Exact™ from ExxonMobil Chemical Co.

In some embodiments of the present invention, a polymer coating composition, described in more detail below, is disposed on at least one side of a substrate. In further embodiments, a second substrate layer may be disposed upon the coating, such that the coating becomes a tie layer between the two substrates. As used herein, the term “disposed” is meant to include any method of placing the substrate in contact with the coating layer, and vice versa, and may include, for example, extrusion coating and extrusion lamination, among other methods. The coatings and substrates may be monoextruded or coextruded. In a coextrusion process, at least two separate polymer compositions are melted and simultaneously extruded, one on top of the other. In this way, articles can be made combining the desired properties of different polymer compositions.

### Propylene-Based Copolymer Coatings

The composite materials of the present invention comprise a coating layer disposed on at least one side of the substrate. In some embodiments, the coating layer comprises a propylene-based copolymer, which comprises propylene and from about 3 to about 25 wt % units derived from ethylene and/or a C₄-C₈ alpha-olefin. In one or more embodiments, the alpha-olefin comonomer units may derive from ethylene, 1-butene, 1-hexene, 4-methyl-1-pentene and/or 1-octene. The embodiments described below are discussed with reference to ethylene as the alpha-olefin comonomer, but the embodiments are equally applicable to other copolymers with other alpha-olefin comonomers. In this regard, the copolymer may simply be referred to as propylene-based copolymers with reference to ethylene as the alpha-olefin.

In one or more embodiments, the propylene-based copolymer may include at least about 3 wt %, at least about 5 wt %, at least about 6 wt %, at least about 8 wt %, or at least about 10 wt % ethylene-derived units. In those or other embodiments, the copolymers may include up to about 25 wt %, or up to about 20 wt %, or up to about 18 wt %, or up to about 16 wt %, or up to about 12 wt % ethylene-derived units, where the percentage by weight is based upon the total weight of the propylene-derived and alpha-olefin derived units. Stated another way, the propylene-based elastomer may include at least about 75 wt %, or at least about 80 wt %, or at least about 82 wt % propylene-derived units; and in these or other embodiments, the copolymers may include up to about 97 wt %, or up to about 95 wt %, or up to about 94 wt %, or up to about 92 wt %, or up to about 90 wt % propylene-derived units, where the percentage by weight is based upon the total weight of the propylene-derived and alpha-olefin derived units.

The propylene-based copolymers of one or more embodiments are characterized by having a single melting temperature as determined by differential scanning calorimetry (DSC). The melting point is defined as the temperature of the greatest heat absorption within the range of melting of the sample. The propylene-based copolymer may show secondary melting peaks adjacent to the principal peak, but for purposes herein, these secondary melting peaks are considered together as a single melting point, with the highest of these peaks being considered the melting point (Tm) of the propylene-based elastomeric copolymer.

In one or more embodiments, the Tm of the propylene-based copolymer (as determined by DSC) is less than about 105° C., or less than about 100° C., or less than about 95° C., or less than about 90° C., or less than about 80° C., or less than about 70° C.

In one or more embodiments, the propylene-based copolymer may be characterized by a heat of fusion (Hf), as determined by DSC. In one or more embodiments, the propylene-based copolymer may be characterized by a heat of fusion that is at least about 0.5 J/g, or at least about 1.0 J/g, or at least about 1.5 J/g, or at least about 3.0 J/g, or at least about 4.0 J/g, or at least about 6.0 J/g, or at least about 7.0 J/g. In these or other embodiments, the propylene-based copolymer may be characterized by a heat of fusion of less than about 75 J/g, or less than about 70 J/g, or less than about 60 J/g, or less than about 50 J/g, or less than about 30 J/g.

If the heat of fusion is too high or not enough comonomer is present, the copolymer may not be sufficiently adhesive. If the heat of fusion is too low, the copolymer may not process stably during extrusion. The heat of fusion may be reduced by using additional comonomer, higher polymerization temperatures and/or a different catalyst that provides reduced levels of steric constraints and favors more propagation errors for propylene insertion.

As used within this specification, DSC procedures for determining Tm and Hf include the following. The polymer is pressed at a temperature of from about 200° C. to about 230° C. in a heated press, and the resulting polymer sheet is hung, under ambient conditions, in the air to cool. About 6 to 10 mg of the polymer sheet is removed with a punch die. This 6 to 10 mg sample is annealed at room temperature for about 80 to 100 hours. At the end of this period, the sample is placed in a Differential Scanning Calorimeter (Perkin Elmer Pyris One Thermal Analysis System) and cooled to about −50° C. to about −70° C. The sample is heated at 10° C./min to attain a final temperature of about 200° C. The sample is kept at 200° C. for 5 minutes and a second cool-heat cycle is performed. Events from both cycles are recorded. The thermal output is recorded as the area under the melting peak of the sample, which typically occurs between about 0° C. and about 200° C. It is measured in Joules and is a measure of the heat of fusion (Hf) of the polymer. The melting point is recorded as the temperature of the greatest heat absorption with respect to a baseline within the range of melting of the sample.

The propylene-based copolymer can have a triad tacticity of three propylene units, as measured by ¹³C NMR, of 75% or greater, 80% or greater, 82% or greater, 85% or greater, or 90% or greater. In one or more embodiments, ranges include from about 50% to about 99%, in other embodiments from about 60% to about 99%, in other embodiments from about 75% to about 99%, in other embodiments from about 80% to about 99%, and in other embodiments from about 60% to about 97%. Triad tacticity is determined by the methods described in U.S. Patent Publication No. 2004-0236042. If the triad tacticity of the copolymer is too high, the level of stereo-irregular disruption of the chain is too low and the material may not be compatible and sufficiently flexible for its purpose in a coating or tie layer. If the triad tacticity is too low, the bonding strength may be too low.

In one or more embodiments, the propylene-based copolymer may have a % crystallinity of from about 0.5% to about 40%, or from about 1% to about 30%, or from about 5% to about 25%, determined according to DSC procedures. Crystallinity may be determined by dividing the heat of fusion of a sample by the heat of fusion of a 100% crystalline polymer, which is assumed to be 189 joules/gram for isotactic polypropylene or 350 joules/gram for polyethylene.

In one or more embodiments, the propylene-based copolymer may have a density of from about 0.85 g/cm³ to about 0.92 g/cm³, or from about 0.87 g/cm³ to about 0.90 g/cm³, or from about 0.88 g/cm³ to about 0.89 g/cm³ at room temperature as measured per the ASTM D-792 test method.

In one or more embodiments, the propylene-based copolymer can have an melt index (MI) (ASTM D-1238, 2.16 kg @ 190° C.), of less than or equal to about 10 g/10 min, or less than or equal to about 7.5 g/10 min, or less than or equal to about 6.5 g/10 min, or less than or equal to about 5.5 g/10 min, or less than or equal to about 5 g/10 min.

In one or more embodiments, the propylene-based copolymer can have a melt flow rate (MFR), as measured according to the ASTM D-1238, 2.16 kg weight @ 230° C., equal to or greater than about 0.3 g/10 min, or at least about 0.5 g/10 min, or at least about 0.8 g/10 min, or at least about 1.0 g/10 min. In these or other embodiments, the melt flow rate may be equal to or less than about 350 g/10 min, or less than about 250 g/10 min, or less than about 100 g/10 min.

In one or more embodiments, the propylene-based copolymer may have a Mooney viscosity [ML (1+4) @ 125° C.], as determined according to ASTM D-1646, of less than about 100, or less than about 75, or less than about 50, or less than about 30.

In one or more embodiments, the propylene-based copolymer can have a weight average molecular weight (Mw) of from about 5,000 to about 5,000,000 g/mole, or from about 10,000 to about 1,000,000 g/mole, or from about 20,000 to about 500,000 g/mole, or from about 50,000 to about 400,000 g/mole.

In one or more embodiments, the propylene-based copolymer can have a number average molecular weight (Mn) of from about 2,500 to about 2,500,000 g/mole, or from about 5,000 to about 500,000 g/mole, or from about 10,000 to about 250,000 g/mole, or from about 25,000 to about 200,000 g/mole.

In one or more embodiments, the propylene-based copolymer can have a Z-average molecular weight (Mz) of from about 10,000 to about 7,000,000 g/mole, or from about 50,000 to about 1,000,000 g/mole, or from about 80,000 to about 700,000 g/mole, or from about 100,000 to about 500,000 g/mole.

In one or more embodiments, the molecular weight distribution (MWD=(Mw/Mn)) of the propylene-based copolymer may be from about 1 to about 40, or from about 1 to about 15, or from about 1.8 to about 5, or from about 1.8 to about 3.

Techniques for determining the molecular weight (Mn, Mw and Mz) and molecular weight distribution (MWD) may be found in U.S. Pat. No. 4,540,753 (Cozewith, Ju and Verstrate) (which is incorporated by reference herein for purposes of U.S. practices) and references cited therein and in Macromolecules, 1988, volume 21, pp. 3360-3371 (Verstrate et al.), which is herein incorporated by reference for purposes of U.S. practices, and references cited therein. For example, molecular weight may be determined by size exclusion chromatography (SEC) by using a Waters 150 gel permeation chromatograph equipped with the differential refractive index detector and calibrated using polystyrene standards.

### Preparation of the Propylene-Based Copolymer

The triad tacticity and tacticity index of the propylene based elastomer may be controlled by the catalyst, which influences the stereoregularity of propylene placement, the polymerization temperature, according to which stereoregularity can be reduced by increasing the temperature, and by the type and amount of a comonomer, which tends to disrupt reduce the level of longer propylene derived sequences.

Too much comonomer will reduce the crystallinity provided by the crystallization of stereoregular propylene derived sequences to the point where the material lacks strength; too little and the material will be too crystalline. The comonomer content and sequence distribution of the polymers can be measured using ¹³C nuclear magnetic resonance (NMR) by methods well known to those skilled in the art. Comonomer content of discrete molecular weight ranges can be measured using methods well known to those skilled in the art, including Fourier Transform Infrared Spectroscopy (FTIR) in conjunction with samples by GPC, as described in Wheeler and Willis, Applied Spectroscopy, 1993, vol. 47, pp. 1128-1130. For a propylene ethylene copolymer containing greater than 75 wt % propylene, the comonomer content (ethylene content) of such a polymer can be measured as follows: A thin homogeneous film is pressed at a temperature of about 150° C. or greater, and mounted on a Perkin Elmer PE 1760 infrared spectrophotometer. A full spectrum of the sample from 600 cm−1 to 4000 cm−1 is recorded and the monomer weight percent of ethylene can be calculated according to the following equation: Ethylene wt %=82.585−111.987X+30.045X2, where X is the ratio of the peak height at 1155 cm−1 and peak height at either 722 cm−1 or 732 cm−1, whichever is higher. For propylene ethylene copolymers having 75 wt % or less propylene content, the comonomer (ethylene) content can be measured using the procedure described in Wheeler and Willis.

Reference is made to U.S. Patent Publication No. 2002-0004575 published Jan. 10, 2002 whose test methods were also fully applicable for the various measurements referred to in this specification and claims and which contains more details on GPC measurements, the determination of ethylene content by NMR and the DSC measurements.

The catalyst may also control the stereoregularity in combination with the comonomer and the polymerization temperature. The catalyst should however be capable of a level of stereoregular placement, generally by suitable chirality of the single site catalyst. The polymer can be prepared using any single sited catalyst. Such a catalyst may be a transition metal complex generally containing a transition metal Groups 3 to 10 of the Periodic Table and at least one ancillary ligand that remains bonded to the transition metal during polymerization. Preferably, the transition metal is used in a reduced cationic state and stabilized by a cocatalyst or activator.

The ancillary ligand may be a structure capable of forming a π bond such a cyclopentadienyl type ring structure (See EP129368, EP284708, Rieger EP1070087, and U.S. Pat. No. 6,559,262). The ancillary ligand may also be a pyridinyl or amide ligand (See WO2003/040201). The transition metal is preferably of Group 4 of the Periodic table such as titanium, hafnium or zirconium, which is used in polymerization in the d0 mono-valent cationic state and has one or two ancillary ligands as described in more detail hereafter. The important features of such catalysts for coordination polymerization are the ligand capable of abstraction and that ligand into which the ethylene (olefinic) group can be inserted.

The manner of activation of the single site catalyst can vary. Alumoxane and preferably methyl alumoxane can be used suitably in an amount to provide a molar aluminum to metallocene ratio of from 1:1 to 20,000:1. Higher molecular weights can be obtained using non-or weakly coordinating anion activators (NCA) derived and generated in any of the ways amply described in published patent art such as EP 277004, EP 426637, EP 426638, and many others. The non-coordinating anion can be a Group 10-14 complex wherein boron or aluminum is the charge-bearing atom shielded by ligands, which may be halogenated, and especially perfluorinated. Preferably tetra-aryl-substituted Group 10-14 non-carbon element-based anion, especially those that are have fluorine groups substituted for hydrogen atoms on the aryl groups, or on alkyl substituents on those aryl groups. The non-coordinating anion may be used in approximately equimolar amounts relative to the transition metal complex, such as at least 0.25, preferably 0.5, and especially 0.8 and such as no more than 4, preferably 2 and especially 1.5. Further options are described in U.S. Pat. No. 6,048,950, WO1998/27154, U.S. Pat. No. 6,448,358, U.S. Pat. No. 6,265,212, U.S. Pat. No. 5,198,401, and U.S. Pat. No. 5,391,629.

The polymerization reaction is conducted by reacting monomers in the presence of a catalyst system described herein at a temperature of from 0° C. to 200° C. for a time of from 1 second to 10 hours. Preferably homogeneous conditions are used, such as a continuous solution process or a bulk polymerization process with excess monomer used as diluent. The continuous process may use some form of agitation to reduce concentration differences in the reactor and maintain steady state polymerization conditions. The heat of the polymerization reaction is preferably removed by cooling of the polymerization feed and allowing the polymerization to heat up to the polymerization, although internal cooling systems may be used.

### Polymer Blends

In some embodiments, the propylene-based copolymers described herein may be blended with one or more other polymers or additives before being applied to the substrate. The one or more other polymers are referred to for the purposes of this disclosure as “secondary polymers”, although they may be present in a blend with the propylene-based copolymer in a majority or minority amount. Suitable secondary polymers which may be blended with the propylene-based copolymers include, but are not limited to, homo- and copolymers of ethylene, homo- and copolymers of propylene, and interpolymers of ethylene or propylene and a copolymerizable ester or acid-group containing monomer.

In one or more embodiments, the secondary polymer is low density polyethylene (LDPE). LDPE may be prepared in high pressure polymerization using free radical initiators, and typically has a density in the range of 0.915-0.935 g/cm³. LDPE is also known as “branched” or “heterogeneously branched” polyethylene because of the relatively large number of long chain branches extending from the main polymer backbone. LDPE has been commercially manufactured since the 1930s and is well known in the art. Polyethylene in an overlapping density range, i.e., 0.890 to 0.945 g/cm³, typically from 0.915 to 0.945 g/cm³, which is linear and does not contain long chain branching is also known. This traditional “linear low density polyethylene” (LLDPE) can be produced with conventional Ziegler-Natta catalysts, vanadium catalysts, or with metallocene catalysts in gas phase reactors and/or with metallocene catalysts in slurry reactors and/or with any of the hafnocene catalysts described herein in solution reactors. The LLDPE reaction systems are relatively low pressure reactor systems. LLDPE has also been commercially manufactured for a long time (since the 1950s for solution reactors, and since the 1980s for gas phase reactors) and is also well known in the art. As used herein, the term “LDPE” shall be assumed to mean both traditional branched LDPE and LLDPE.

In other embodiments, the secondary polymer is a polypropylene. The polypropylene may be either a homopolymer of propylene or a copolymer with other alpha olefins. The polypropylene may also be comprised of commonly available isotactic polypropylene compositions referred to as impact copolymers or reactor copolymers, or may be those polypropylene copolymers referred to as random copolymers of propylene, or RCPs. In some embodiments, the polypropylene has a melting temperature (Tm) greater than about 110° C., or greater than about 115° C., or greater than about 130° C. In the same or other embodiments, the polypropylene has a heat of fusion of at least 75 J/g, as determined by DSC analysis. The polypropylene may also contain additives such as flow improvers, nucleators and antioxidants which are normally added to isotactic polypropylene to improve or retain properties. All of these polymers are referred to as polypropylene.

In further embodiments, the secondary polymer may be an ethylene acrylic acid copolymer (EAA) of ethylene and acrylic acid or a terpolymer such as random terpolymer of ethylene, acrylic ester and maleic anhydride, or may be a copolymer of ethylene and vinyl acetate (EVA), or may be a maleated ethylene or propylene copolymer. Exemplary secondary polymers of these types include maleic anhydride grafted copolymers of ethylene or propylene, such as those available under the trade name Exxelor™ from ExxonMobil Chemical Co., EVAs comprising from about 5 to about 40 wt % units derived from vinyl acetate, examples of which are available under the trade name Escorene™ from ExxonMobil Chemical Co., EAA and EMAAA available under the trade name Escor™ from ExxonMobil Chemical Co. and terpolymers of ethylene, acrylic ester, and maleic anhydride such as those available under the trade name Lotader from Arkema Chemicals.

In further embodiments, the secondary polymer may be a polymer which meets the description of the propylene-based copolymers described herein, but is different from the first propylene-based copolymer in some manner. For example, the polymer blend may include a first propylene-based polymer having a comparatively low ethylene content and a secondary propylene-based polymer having a comparatively high ethylene content. Such blends may be formed by physically blending the polymer components, such as in a mixer or extruder, or by reactor blending.

In some embodiments, the coating comprises from about 5 to about 95 wt % of the propylene-based copolymer and from about 95 to about 5 wt % of the secondary polymer. In further embodiments, the coating may comprise from about 20 to about 80 wt % of the propylene-based copolymer and from about 80 to about 20 wt % of the secondary polymer.

In the same or other embodiments, the propylene-based copolymers described herein may be blended with one or more additives, either alone or in combination with a secondary polymer. Suitable additives are well known in the art and may be chosen according to the desired end use of the composite material. Exemplary additives include, but are not limited to, coagents, antioxidants, fillers, antiblocking agents, slip agents, release agents, antistatic agents, ultraviolet stabilizers, pigments, coloring agents, nucleating agents, fire or flame retardants, plasticizers, vulcanizing or curative agents, vulcanizing or curative accelerators, tackifiers, flow improvers, lubricants, mold release agents, foaming agents, reinforcers, and processing aids. The additives can be added to the blend in pure form or in master batches.

### Coating the Substrate

In one or more embodiments of the present invention, a composite material is formed by providing a substrate as previously described and extruding a coating comprising a propylene-based copolymer as described herein onto at least one side of the substrate. In one or more embodiments, the coating provides sufficient adhesion to the substrate such that the use of a primer is unnecessary. In other words, the coating is extruded onto the substrate without the interposition of a primer between the substrate and the coating. In one or more embodiments, the coating may be extrusion laminated onto at least one side of 2 substrates, and in some embodiments the coating is extrusion laminated onto the substrates without the interposition of a primer between the substrate and the coating.

The amount of coating applied to the substrate is measured in grams per square meter, or gsm. In one or more embodiments, the coatings of the present invention are applied to the substrate in an amount of from about 5 to about 250 gsm, or from about 10 to about 200 gsm, or from about 15 to about 150 gsm. Persons of skill in the art will realize, however, that the coatings may be applied in greater or lesser amounts depending upon the desired use of the composite material, the mechanical properties desired, and whether the propylene-based copolymer is used as an outer coating on the substrate or as a tie layer. In some embodiments of the present invention, a coating is extruded onto both sides of the substrate. The coating may be the same on each side or different, and the coating on each side may be a propylene-based copolymer as described herein or may be a polymer of a different composition.

In some embodiments of the present invention, the coating may be a monoextruded layer. In a monoextrusion process, the coating layer is applied as a single layer. In other embodiments, the coating may be a coextruded layer. In a coextrusion process, two or more layers are applied by extrusion at the same time onto a substrate. A coextrusion process may be used to apply a single layer of coating material on each side of a substrate simultaneously, or may be used to apply two or more layers of coating material on top of one another on a single side of the substrate. The coating layers applied in a coextrusion process may be the same or different, and one or both of the coextruded layers may comprise a propylene-based copolymer as described herein. For example, in some embodiments of the present invention, a substrate is coextrusion coated with a propylene-based copolymer as a sealing layer and an additional outer layer, which may or may not be a propylene-based copolymer, on top of the sealing layer. In other embodiments, a substrate may be coextrusion coated with a sealing layer, which may or may not be a propylene-based copolymer, and an additional outer layer comprising a propylene-based copolymer on top of the sealing layer.

Extrusion processes are well known in the art, and suitable extrusion process conditions may be selected by persons of skill in the art in accordance with the desired coating type, coating amount, substrate, and desired end result. In some embodiments of the present invention, the coatings described herein are extruded at a temperature of from about 170° C. to about 330° C.

In further embodiments of the present invention, one or more additional substrate layers may be disposed upon the coating layer (which is disposed upon a first substrate as described previously), such that the coating layer becomes a tie layer between the first and second (or more) substrate layers. In such embodiments, each substrate layer may be the same as or different from the other substrate layer(s), and may comprise any of the previously described substrate materials. In one embodiment, the second layer comprises a copolymer of ethylene and a C₄-C₈ alpha-olefin. In a further embodiment, the second layer comprises an extensible nonwoven material. In the same or other embodiments, both the first and second substrate layers comprise extensible nonwoven materials.

### Properties of the Coatings and Resulting Composite Materials

The coatings and composite materials described herein exhibit exceptional thermal, adhesive, and mechanical properties. For example, the coatings described herein have low seal initiation temperatures, high seal strength, high bond strength, good adhesion, good hot tack properties, good surface blocking, and good moisture barrier properties, at both high and low temperatures. Notably, the coatings exhibit these properties without the use of a primer layer interposed between the substrate and the coating. The coatings described herein also allow for downgauging and higher line speeds when compared to coatings formed from other polymers. Further, when the coatings are applied to extensible, or stretch, materials, the coatings improve elasticity, lower tension set, and lower hysteresis of the composite material. With reference to the properties further discussed below, use of the phrase “propylene-based copolymer coating” includes coatings comprising the propylene-based copolymers described herein and coatings comprising blends of the propylene-based copolymers with one or more additional polymers and/or one or more additives.

In one or more embodiments, the propylene-based copolymer coatings described herein may have a seal initiation temperature less than about 130° C., or less than about 120° C., or less than about 110° C., or less than about 100° C., or less than about 90° C. In the same or other embodiments, the coatings may have a water vapor transmission rate (WVTR) of greater than about 20, or greater than about 25, or greater than about 30 g/m²/24 hours at 90% RH and 37.8° C. In other embodiments, the coatings may have a water vapor transmission rate (WVTR) of less than about 75, or less than about 65, or less than about 50, or less than about 40 g/m²/24 hours at 90% RH and 37.8° C.

In one or more embodiments, the propylene-based copolymer coatings have a kinetic coefficient of friction (“COF”) greater than about 0.75, or greater than about 0.8, or greater than about 0.9, or greater than about 1.0. In the same or other embodiments, the coatings have a static COF greater than about 0.75, or greater than about 0.9, or greater than about 1.0, or greater than about 1.25. In further embodiments, the coatings provide sufficient slip resistance such that the slide angle to initiate movement of a coated substrate is greater than about 25°, or greater than about 30°, or greater than about 40°.

In one or more embodiments, the propylene-based copolymer coatings may be applied to OPP films at a coating level of 25 gsm, resulting in a bond strength greater than 2.4 N/15mm. In further embodiments, the propylene-based copolymer coatings may be applied to reverse printed OPP films at a coating level of 30 gsm, resulting in a bond strength greater than about 1.5 N/15mm. In one or more embodiments, the propylene-based copolymer coatings provide adequate adhesion such that the failure mechanism of a composite material comprising the coating is cohesive failure.

In one or more embodiments, the propylene-based copolymer coatings may be applied to extensible nonwoven substrates, resulting in a composite structure having a permanent set of less than about 15% (second unload at 0.1N).

In one or more embodiments, the propylene-based copolymer coating additionally comprises an EVA copolymer, and the resulting coatings exhibit a hot tack peak force at least twice as great as that of coatings formed from EVA alone.

Further illustration of the above-described properties and others is provided with reference to the examples and figures below.

### EXAMPLES

With reference to the following examples and figures, the following identifiers are used:

Copolymer A is a propylene-based copolymer as described herein, with an ethylene content of about 15 wt % and an MFR of about 18 g/10 min (230° C., 2.16 kg);
Copolymer B is a propylene-based copolymer as described herein, with an ethylene content of about 9 wt % and an MIFR of about 8 g/10 min (230° C., 2.16 kg);
PE 1 is an ethylene-octene copolymer having a density of about 0.882 g/cm3 and a melt index (MI) of about 1.1 g/10 min (190° C., 2.16 kg);
PE 2 is an ethylene-octene copolymer having a density of about 0.902 g/cm³ and an MI of about 1.1 g/10 min (190° C., 2.16 kg);
EVA 1 is an ethylene vinyl acetate copolymer, with a vinyl acetate content of about 14 wt % and an MI of about 7.5 g/10 min (2.16 kg, 190° C.);
EVA 2 is an ethylene vinyl acetate copolymer, with a vinyl acetate content of about 18 wt % and an MI of about 14 g/10 min (2.16 kg, 190° C.);
LDPE 1 is a low density polyethylene having a density of about 0.918 g/cm³ and an MI of about 8.2 g/10 min (2.16 kg, 190° C.);
LDPE 2 is a low density polyethylene having a density of about 0.915 g/cm³ and an MI of about 12 g/10 min (2.16 kg, 190° C.);
PP is a propylene homopolymer having a density of about 0.9 g/cm³ and an MFR of about 25 g/10 min (2.16 kg, 230° C.);
MAH-g PE is a maleic anhydride-grafted semi-crystalline ethylene copolymer having a density of about 0.88 g/cm³ and an MI of about 8.0 g/10 min (5 kg, 230° C.); and
EMAAH is a random polymer of ethylene, acrylic ester, and maleic anhydride available under the trade name Lotader 4503 from Arkema Chemicals.

Composite materials were formed comprising various substrates and combinations of propylene-based copolymer coatings or tie layers as described herein. Those composite materials were tested for a variety of thermal, adhesive, tensile, and mechanical properties. The resulting measurements are reflected in the tables and figures as described below.

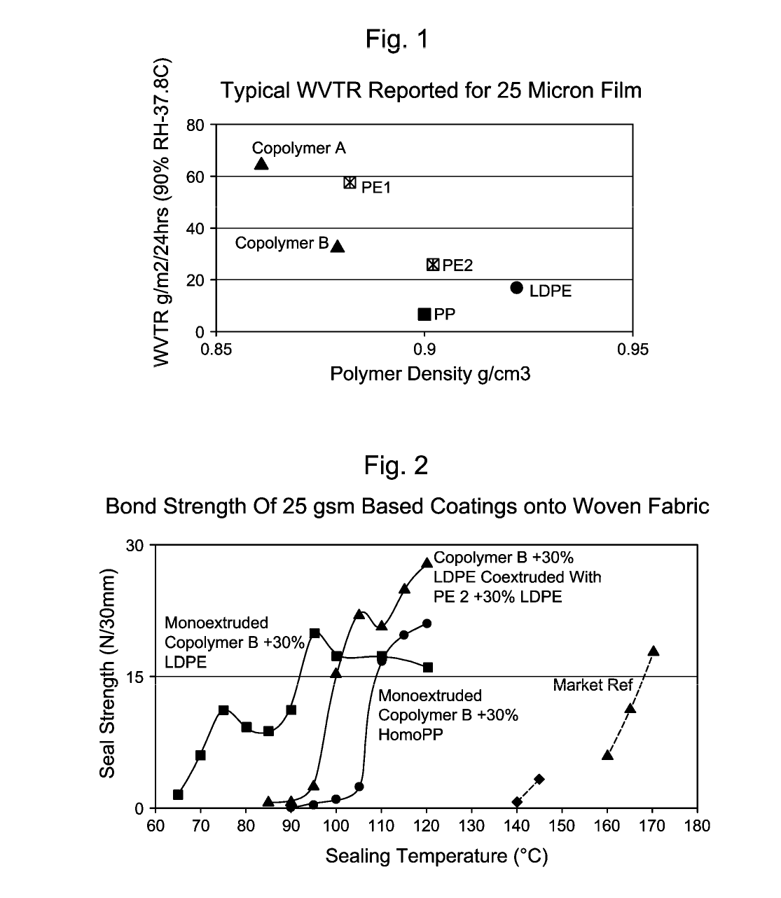

FIG. 1 depicts water vapor transmission rate (in g/m²/24 hrs @ 90% RH and 37.8° C.) as a function of polymer density for 25 micron films formed from copolymers of the present invention as well as for a number of comparative polymers. As shown in the figure, coatings formed from propylene-based copolymers of the invention exhibit two to three times greater water vapor transmission rates than those of LDPE and PP. Additionally, coatings formed from propylene-based copolymers of the invention having a lower ethylene content exhibit water vapor transmission rates lower than those propylene-based copolymers having a higher ethylene content, as shown by the differing results for Copolymer A and Copolymer B.

FIG. 2 depicts seal strength (in N/30mm) as a function of sealing temperature (° C.) for 25 g/m² (“gsm”) coatings on woven fabric, including coatings formed from copolymer blends of the present invention and reference materials. As shown in the figure, a significant reduction in seal initiation temperature is observed when the coatings comprise a propylene-based copolymer as described herein.

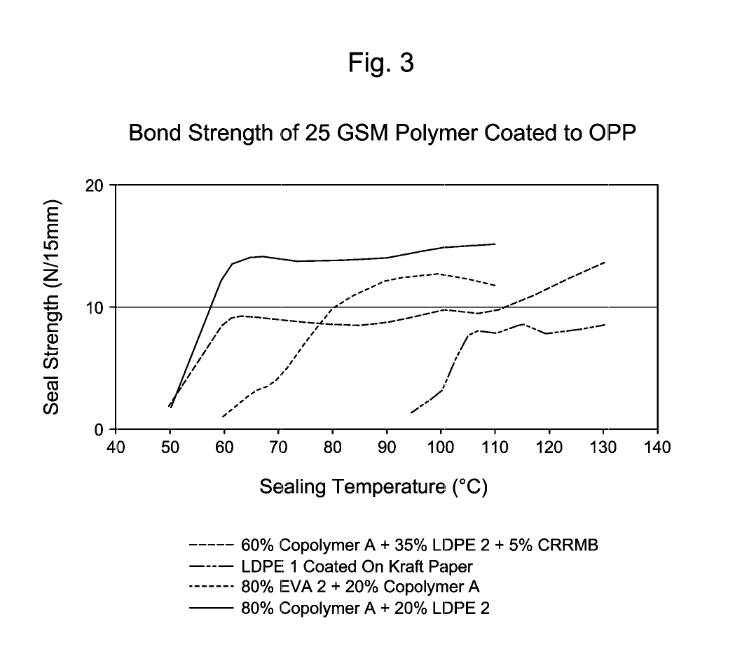

FIG. 3 depicts seal strength (in N/15 mm) as a function of sealing temperature (° C.) for 25 gsm seal layer coatings on oriented polypropylene (“OPP”), including coatings formed from copolymer blends of the present invention and coatings of LDPE on kraft paper. Once again, very low seal initiation temperatures (less than 70° C., and some less than 60° C.) are observed for coating layers comprising Copolymer A. Additionally, higher seal strength is exhibited by the coatings comprising Copolymer A, which allows for downgauging of the sealing layer.

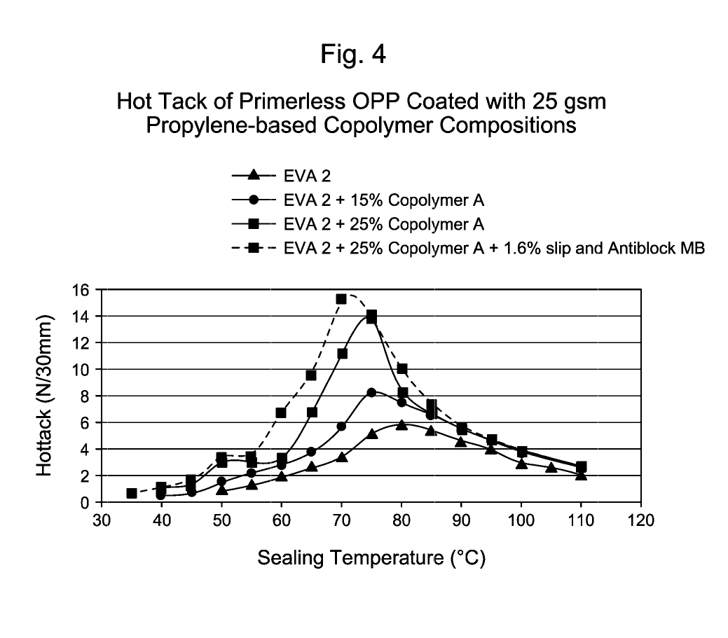

FIG. 4 depicts hot tack (in N/30 mm) as a function of sealing temperature (° C.) for 25 gsm coatings on primerless OPP for coatings formed from EVA and from EVA blended with copolymers of the present invention. As shown in the figure, coatings comprising EVA blended with Copolymer A exhibit significantly greater hot tack than a coating comprising EVA alone. In some cases, the hot tack of the blended coatings is at least twice that of the coating comprising EVA alone.

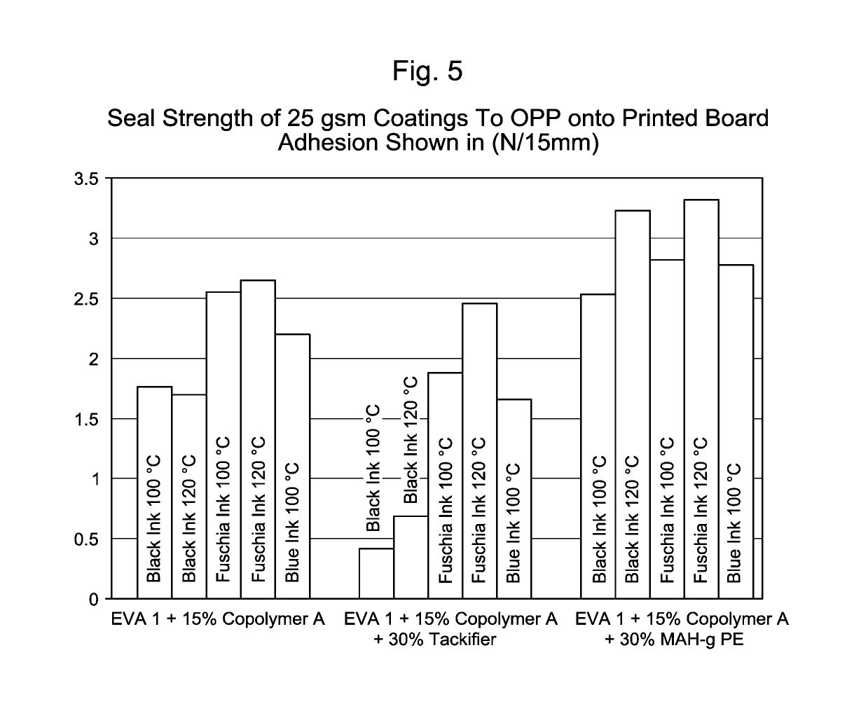

FIG. 5 depicts seal strength for 25 gsm coatings on printed OPP boards for blends of EVA and copolymers of the present invention. FIG. 5 shows adhesion (in N/15 mm) for three colors of ink at 100° C. and 120° C. As shown in the figure, coatings formed from blends comprising propylene-based copolymers as described herein exhibit excellent adhesion to printed materials, even in the absence of primer. Particularly good results are obtained when the coating blends comprise an amount of a grafted resin such as a maleic anhydride-grafter ethylene copolymer.

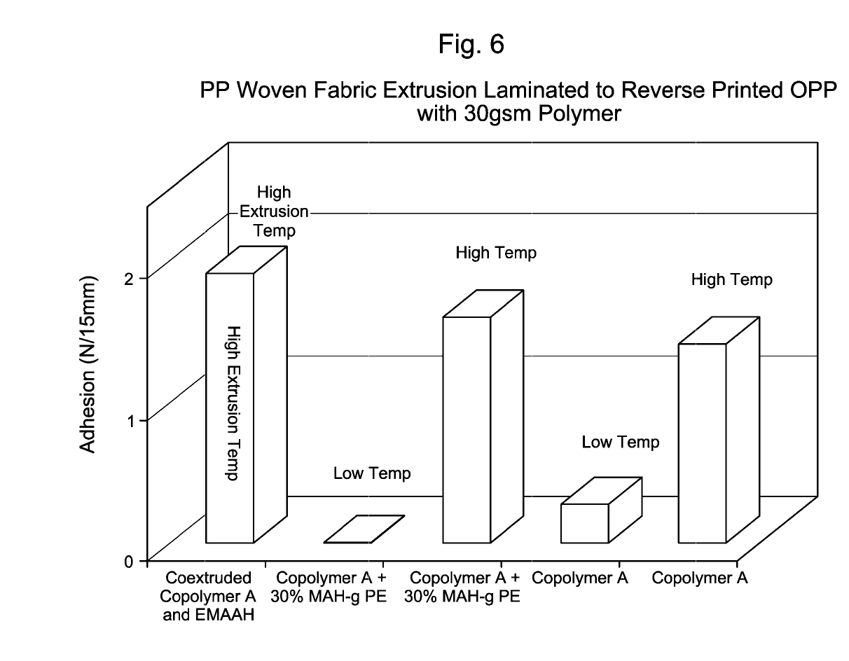

FIG. 6 depicts adhesion (in N/15mm) at high and low extrusion temperatures for 30 gsm tie layers comprising copolymers of the present invention used to adhere woven polypropylene fabric to reverse printed OPP films. As shown in the figure, high adhesion is achieved using coatings comprising propylene-based copolymers as described herein in both monoextrusion and coextrusion lamination processes at high temperatures.

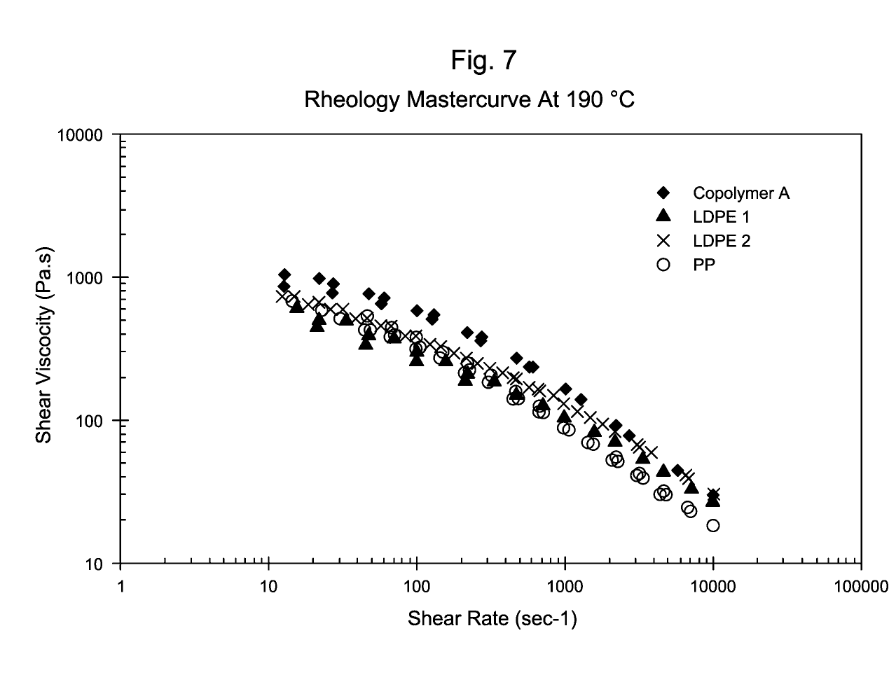

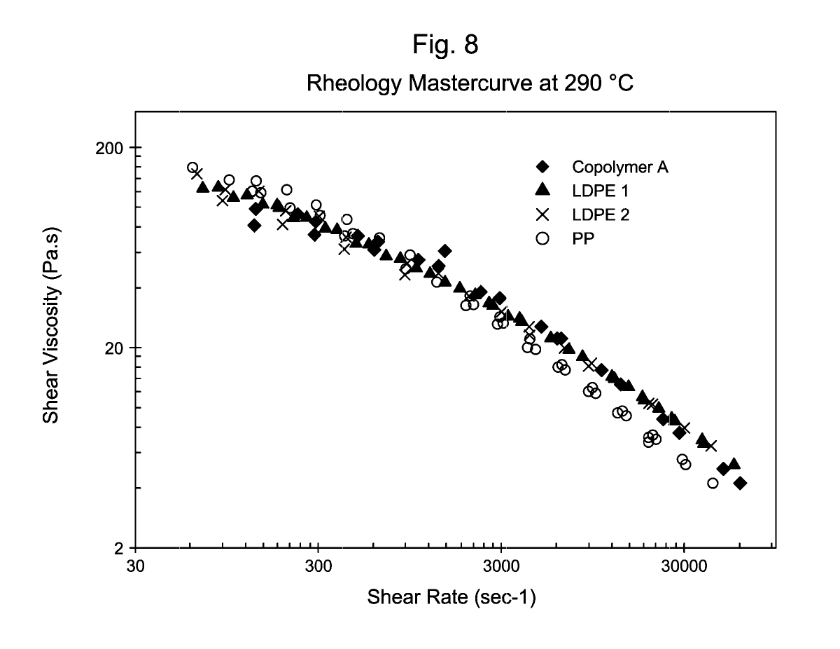

FIG. 7 depicts shear viscosity (in Pa-s) as a function of shear rate (in sec⁻¹) for a copolymer of the present invention and for several comparative polymers at 190° C. FIG. 8 depicts shear viscosity (in Pa-s) as a function of shear rate (in sec⁻¹) for a copolymer of the present invention and for several comparative polymers at 290° C. As reflected in FIGS. 7 and 8, the propylene-based copolymers as described herein are compatible with a wide variety of other polymers, exhibiting excellent processing in blends, and coextruding well with other polymers. The propylene-based copolymer coatings may be extruded over a wide range of temperatures. Additionally, the flow behavior of the copolymers is similar to that of homopolypropylene, but crystallization is typically slower.

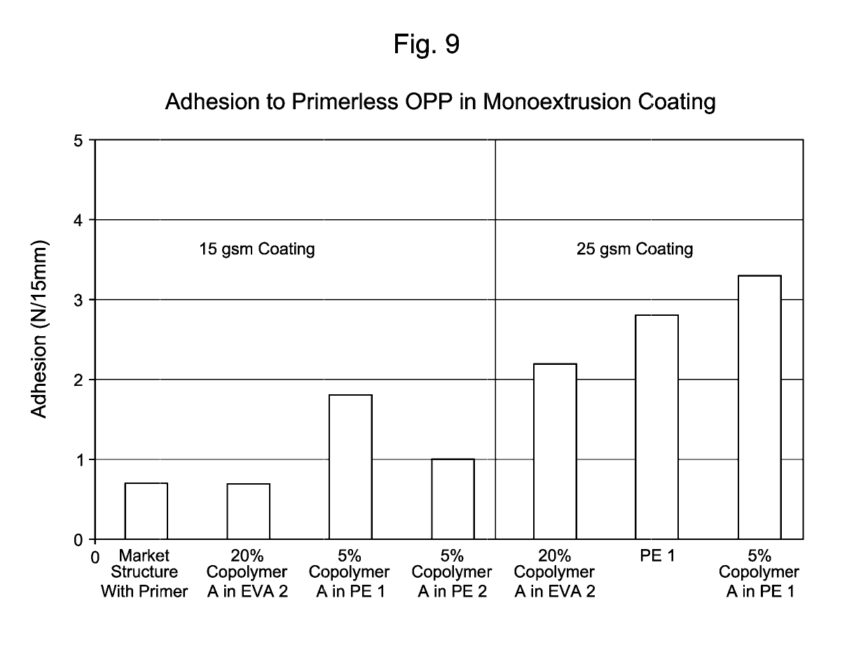

FIG. 9 depicts adhesion (in N/15 mm) to primerless OPP films for monoextruded 15 gsm and 25 gsm coatings comprising copolymers of the present invention, as well as for monoextruded coatings comprising comparative polymers with and without primer. As shown in the figure, excellent adhesion is achieved using coatings comprising propylene-based copolymers as described herein without the use of primer. Further, the propylene-based copolymers may be used to enhance adhesion in coatings comprising EVA and plastomers.

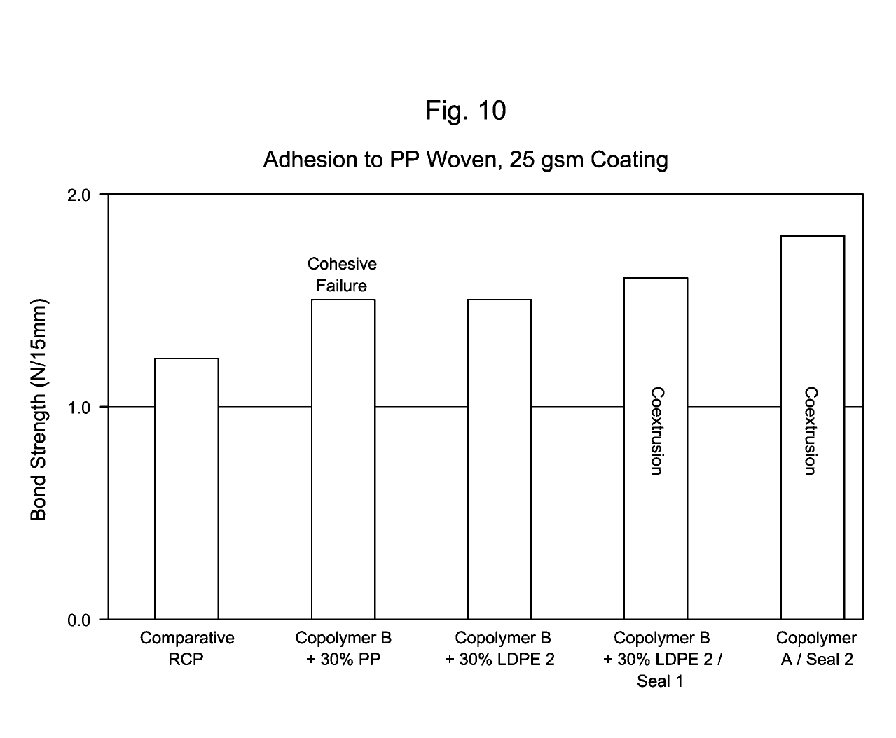

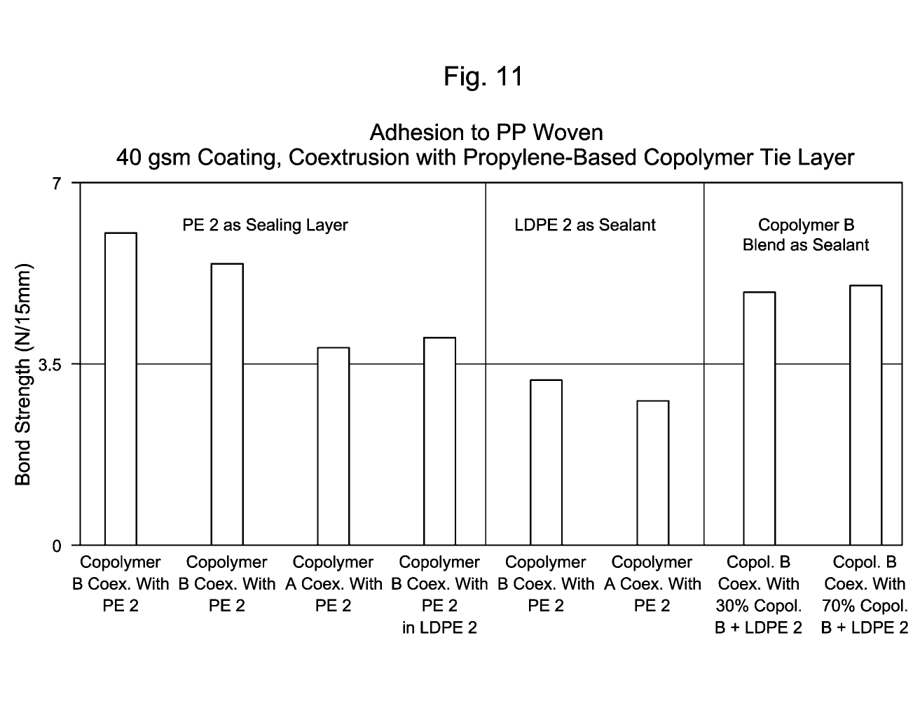

FIG. 10 depicts bond strength (in N/15 mm) for 25 gsm coatings on woven polypropylene fabrics for copolymer blends of the present invention and for a comparative polymer. FIG. 11 depicts bond strength (in N/15 mm) for 40 gsm coatings on woven polypropylene fabrics for copolymer blends of the present invention coextruded with sealing layers formed from polyethylene and from a copolymer of the present invention. As reflected in FIGS. 10 and 11, structures comprising coating or tie layers which include propylene-based copolymers as described herein outperform market reference materials. Further, increased adhesion is obtained using a coextrusion process in which the tie layer comprises a propylene-based copolymer.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below.

For purposes of convenience, various specific test procedures are identified herein for determining certain properties such as melt flow rate, melt index, seal strength, bond strength, tension set, etc. However, when a person of ordinary skill reads this patent and wishes to determine whether a composition or polymer has a particular property identified in a claim, then any published or well-recognized method or test procedure can be followed to determine that property, although the specifically identified procedure is preferred. Each claim should be construed to cover the results of any of such procedures, even to the extent different procedures can yield different results or measurements. Thus, a person of ordinary skill in the art is to expect experimental variations in measured properties that are reflected in the claims. All numerical values are considered to be “about” or “approximately” the stated value, in view of the nature of testing in general.

To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

Each of the appended claims defines a separate invention, which for infringement purposes is recognized as including equivalents of the various elements or limitations specified in the claims. Depending on the context, all references herein to the “invention” may in some cases refer to certain specific embodiments only. In other cases it will be recognized that references to the “invention” will refer to subject matter recited in one or more, but not necessarily all, of the claims. Each of the inventions is described herein, including specific embodiments, versions and examples, but the inventions are not limited to these embodiments, versions or examples, which are included to enable a person having ordinary skill in the art to make and use the inventions, when the information in this patent is combined with available information and technology.

Further embodiments include:

A. A composite material comprising:
a. a substrate layer; and
b. a coating disposed on at least one side of the substrate; wherein the coating comprises a propylene-based copolymer comprising propylene and from about 3 to about 25 wt % units derived from ethylene and/or a C₄-C₈ alpha-olefin, and where the propylene-based copolymer has a melting temperature less than about 105° C. and a heat of fusion less than about 75 J/g.
   B. The composite material of embodiment A, wherein the substrate comprises a film, membrane, woven fabric, nonwoven fabric, raffia or a tape.
   C. The composite material of embodiment A, wherein the substrate comprises plastic, paper, cardboard, wood, metal, foil, printed film, reverse printed film, or a combination thereof.
   D. The composite material of any of embodiments A-C, wherein the substrate comprises a homopolymer or copolymer of propylene.
   E. The composite material of any of embodiments A-C, wherein the substrate comprises oriented polypropylene.
   F. The composite material of any of embodiments A-E, wherein the coating is a monoextruded layer.
   G. The composite material of any of embodiments A-E, wherein the coating is a coextruded layer.
   H. The composite material of any of embodiments A-G, wherein the coating is disposed on both sides of the substrate.
   I. The composite material of any of embodiments A-G, wherein the coating is disposed on one side of the substrate and a second coating having a different composition is disposed on the opposite side of the substrate.
   J. The composite material of any of embodiments A-I, further comprising a second substrate layer disposed upon the coating.
   K. The composite material of embodiment J, wherein the second substrate layer comprises a copolymer of ethylene and a C₄-C₈ alpha-olefin.
   L. The composite material of any of embodiments A-K, wherein the coating is disposed on the substrate in an amount of from about 3 to about 250 grams per square meter (gsm).
   M. The composite material of any of embodiments A-L, wherein the coating has a seal initiation temperature less than about 120° C.
   N. The composite material of any of embodiments A-L, wherein the coating has a seal initiation temperature less than about 100° C.
   O. The composite material of any of embodiments A-N, wherein the coating further comprises a second polymer.
   P. The composite material of embodiment O, wherein the second polymer is a homo-, co-, or terpolymer of ethylene, a homo-, co-, or terpolymer of propylene, or an interpolymer of ethylene and a copolymerizable ester or acid group-containing monomer.
   Q. The composite material of embodiment O, wherein the second polymer is low density polyethylene (LDPE).
   R. The composite material of embodiment O, wherein the second polymer is a homopolymer or copolymer of polypropylene.
   S. The composite material of any of embodiments O-R, wherein the coating comprises from about 5 to about 95 wt % of the propylene-based polymer and from about 5 to about 95 wt % of the second polymer.
   T. The composite material of any of embodiments O-R, wherein the coating comprises from about 20 to about 80 wt % of the propylene-based polymer and from about 20 to about 80 wt % of the second polymer.
   U. The composite material of any of embodiments A-T, wherein the coating has a kinetic coefficient of friction greater than about 0.75.
   V. The composite material of any of embodiments A-U, wherein the coating has a kinetic coefficient of friction greater than about 1.0.
   W. The composite material of any of embodiments A-V, wherein the slide angle to initiate movement of the coated material is greater than 25°.
   X. The composite material of any of embodiments A-W, wherein the water vapor transmission rate of the coating is greater than about 20 g/m²/24 hrs (@ 90% RH and 37.8° C.).
   Y. The composite material of any of embodiments A-W, wherein the water vapor transmission rate of the coating is greater than about 30 g/m²/24 hrs (@ 90% RH and 37.8° C.).
   Z. The composite material of embodiment O, where the second polymer is a copolymer of ethylene and vinyl acetate (EVA), and wherein the coating has a hot tack peak force at least twice that of pure EVA.
   AA. The composite material of any of embodiments A-Z, wherein the propylene-based copolymer comprises from about 3 to about 16 wt % ethylene.
   BB. The composite material of any of embodiments A-Z, wherein the propylene-based copolymer comprises from about 5 to about 12 wt % ethylene.
   CC. The composite material of any of embodiments A-BB, wherein the substrate is oriented polypropylene (OPP) film, the coating level is 25 gsm, and the coating has a bond strength greater than 2.4N/15 mm.
   DD. The composite material of any of embodiments A-BB, wherein the substrate is reverse printed oriented polypropylene (OPP) film, the coating level is 30 gsm, and the coating has a bond strength greater than 1.5N/15 mm.
   EE. The composite material of any of embodiments A-DD, wherein the substrate is an extensible nonwoven material and wherein the composite material has a permanent set of less than about 15% (second unload at 0.1N).
   FF. A bag formed from the composite material of any of embodiments A-EE.
   GG. A pouch formed from the composite material of any of embodiments A-EE.
   HH. An elastic laminate formed from composite of any of embodiments A-EE.
   II. A process for the formation of a composite material comprising:

a. providing a substrate;

b. extruding onto at least one side of the substrate a coating comprising a propylene-based copolymer, wherein the propylene-based copolymer comprises propylene and from about 3 to about 25 wt % units derived from ethylene and/or a C₄-C₈ alpha-olefin and has a melting temperature less than about 105° C. and a heat of fusion less than about 75 J/g.

JJ. The process of embodiment II, wherein the coating is extruded onto the substrate without the interposition of a primer between the substrate and the coating.
KK. The process of embodiment II, wherein the coating is extrusion laminated onto the substrate without the interposition of a primer between the substrate and the coating.
LL. The process of any of embodiments II-KK, further comprising providing a second substrate, where the first and second substrates are both extensible nonwoven fabrics and wherein the coating is extrusion laminated between the two substrates.
MM. The process of any of embodiments II-LL, wherein the coating is extruded onto both sides of the substrate.
NN. The process of any of embodiments II-MM, further comprising disposing a second layer upon the coating.
OO. The process of any of embodiments II-NN, wherein the coating provides adequate adhesion such that the failure mechanism of the composite material is cohesive failure.
PP. The process of any of embodiments II-OO, wherein the coating is extruded at a temperature of from about 170° C. to about 330° C.
QQ. The process of any of embodiments II-OO, wherein the coating is extruded at a temperature of from about 170° C. to about 330° C.
RR. The process of any of embodiments II-QQ, wherein the substrate comprises a film, membrane, woven fabric, nonwoven fabric, raffia, or tape.
SS. The process of any of embodiments II-QQ, wherein the substrate comprises plastic, paper, cardboard, wood, metal, foil, printed film, reverse printed film, or a combination thereof.
TT. The process of any of embodiments II-SS, wherein the substrate comprises a homopolymer or copolymer of propylene.
UU. The process of any of embodiments II-SS, wherein the substrate comprises oriented polypropylene.
VV. The process of embodiment LL, wherein the second layer comprises a copolymer of ethylene and a C₄-C₈ alpha-olefin.
WW. The process of any of embodiments II-VV, wherein the coating is extruded onto the substrate in an amount of from about 5 to about 250 grams per square meter (gsm).
XX. The process of any of embodiments II-WW, wherein the coating has a seal initiation temperature less than about 120° C.
YY. The process of any of embodiments II-WW, wherein the coating has a seal initiation temperature less than about 100° C.
ZZ. The process of any of embodiments II-YY, wherein the coating further comprises a second polymer.
AAA. The process of embodiment ZZ, wherein the second polymer is a homo-, co-, or terpolymer of ethylene, a homo-, co-, or terpolymer of propylene, or an interpolymer of ethylene and a copolymerizable ester or acid group-containing monomer.
BBB. The process of embodiment ZZ, wherein the second polymer is low density polyethylene (LDPE).
CCC. The process of embodiment ZZ, wherein the second polymer is polypropylene.
DDD. The process of any of embodiments II-CC, wherein the coating comprises from about 5 to about 95 wt % of the propylene-based polymer and from about 5 to about 85 wt % of the second polymer.
EEE. The process of any of embodiments II-CC, wherein the coating comprises from about 20 to about 80 wt % of the propylene-based polymer and from about 20 to about 80 wt % of the second polymer.
FFF. The process of any of embodiments II-EEE, wherein the coating has a kinetic coefficient of friction greater than about 0.75.
GGG. The process of any of embodiments II-EEE, wherein the coating has a kinetic coefficient of friction greater than about 1.0.
HHH. The process of any of embodiments II-GGG, wherein the slide angle to initiate movement of the composite material is greater than 25°.
III. The process of any of embodiments II-HHH, wherein the water vapor transmission rate of the coating is greater than about 20 g/m²/24 hrs (@0 90% RH and 37.8° C.).
JJJ. The process of any of embodiments II-HHH, wherein the water vapor transmission rate of the coating is greater than about 30 g/m²/24 hrs (@ 90% RH and 37.8° C.).
KKK. The process of embodiment ZZ, where the second polymer is a copolymer of ethylene and vinyl acetate (EVA), and wherein the coating has a hot tack peak force at least twice that of pure EVA.
LLL. The process of any of embodiments II-KKK, wherein the propylene-based copolymer comprises from about 3 to about 16 wt % ethylene.
MMM. The process of any of embodiments II-KKK, wherein the propylene-based copolymer comprises from about 5 to about 12 wt % ethylene.
NNN. The process of any of embodiments II-MMM, wherein the substrate is oriented polypropylene (OPP) film, the coating level is 25 gsm, and the coating has a bond strength greater than 2.4 N/15 mm.
OOO. The process of any of embodiments II-MMM, wherein the substrate is polypropylene fabric, the coating level is 125 gsm, and the coating has a bond strength greater than 14N/15mm.
PPP. The process of any of embodiments II-MMM, wherein the substrate is an extensible nonwoven fabric and wherein the composite material has a permanent set of less than about 15% (second unload at 0.1N).

We claim:

1. A composite material comprising:
a. a substrate layer; and
b. a coating disposed on at least one side of the substrate;
wherein the coating comprises a propylene-based copolymer comprising propylene and from about 3 to about 25 wt % units derived from ethylene and/or a C₄-C₈ alpha-olefin, and where the propylene-based copolymer has a melting temperature less than about 105° C. and a heat of fusion less than about 75 J/g.

2. The composite material of claim 1, wherein the substrate comprises a film, membrane, woven fabric, nonwoven fabric, raffia, tape, plastic, paper, cardboard, wood, metal, foil, printed film, reverse printed film, or a combination thereof.

3. The composite material of claim 2, wherein the substrate comprises a homopolymer or copolymer of propylene.

4. The composite material of claim 1, wherein the coating is a monoextruded layer.

5. The composite material of claim 1, wherein the coating is a coextruded layer.

6. The composite material of claim 1, wherein the coating is disposed on both sides of the substrate.

7. The composite material of claim 1, further comprising a second substrate layer disposed upon the coating.

8. The composite material of claim 7, wherein the second substrate layer comprises a copolymer of ethylene and a C₄-C₈ alpha-olefin.

9. The composite material of claim 1, wherein the coating is disposed on the substrate in an amount of from about 3 to about 250 grams per square meter (gsm).

10. The composite material of claim 1, wherein the coating has a seal initiation temperature less than about 120° C.

11. The composite material of claim 1, wherein the coating further comprises a second polymer.

12. The composite material of claim 11, wherein the second polymer is a homo-, co-, or terpolymer of ethylene, a homo-, co-, or terpolymer of propylene, or an interpolymer of ethylene and a copolymerizable ester or acid group-containing monomer.

13. The composite material of claim 1, wherein the coating has a kinetic coefficient of friction greater than about 0.75.

14. The composite material of claim 1, wherein the water vapor transmission rate of the coating is greater than about 20 g/m²/24 hrs (@ 90% RH and 37.8° C.).

15. The composite material of claim 1, wherein the propylene-based copolymer comprises from about 3 to about 16 wt % ethylene.

16. A process for the formation of a composite material comprising:
a. providing a substrate;
b. extruding onto at least one side of the substrate a coating comprising a propylene-based copolymer, wherein the propylene-based copolymer comprises propylene and from about 3 to about 25 wt % units derived from ethylene and/or a C₄-C₈ alpha-olefin and has a melting temperature less than about 105° C. and a heat of fusion less than about 75 J/g.

17. The process of claim 16, wherein the coating is extruded onto the substrate without the interposition of a primer between the substrate and the coating.

18. The process of claim 16, further comprising providing a second substrate, where the first and second substrates are both extensible nonwoven fabrics and wherein the coating is extrusion laminated between the two substrates.

19. The process of claim 16, wherein the coating is extruded onto both sides of the substrate.

20. The process of claim 16, further comprising disposing a second layer upon the coating.
